(19) United States
(12) Patent Application Publication
(10) Pub. No.: US 2018/0295212 A1
(43) Pub. Date: Oct. 11, 2018

(54) SYSTEM, DEVICE AND SERVER FOR GENERATING ADDRESS DATA FOR PART OF CONTENTS IN ELECTRONIC BOOK

(71) Applicant: Bukio Corp, Seongnam-si (KR)

(72) Inventor: Min Su KANG, Seongnam-si (KR)

(73) Assignee: Bukio Corp, Seongnam-si (KR)

(21) Appl. No.: 15/481,809

(22) Filed: Apr. 7, 2017

(51) Int. Cl. H04L 29/06; G06F 17/30; G06F 21/10; H04L 29/12; G06T 11/60

(52) U.S. Cl. CPC H04L 67/42; G06F 17/30887; G06F 21/10; G06F 3/04842; G06T 11/60; G06F 2221/0748; H04L 61/6004; H04L 61/20

(57) ABSTRACT

A system for generating address data for some content included in an e-book, including: a first terminal configured to receive some characters selected from among a plurality of characters included in content of an e-book through an interface, process the received characters as a first area, and generate address data using ID values for the first area, an e-book server configured to receive the address data from the first terminal, register the received address data in a database, and process an access of at least one terminal to the first area according to a result of comparing address data transmitted from the at least one terminal with the registered address data, and a second terminal configured to receive the address data from the first terminal, access the first area of the e-book server on the basis of the address data, and output the first area on a screen thereof.

### BACKGROUND

### 1. Field of the Invention

The disclosed technique relates to a system, terminal, and server for generating address data of some content included in an e-book.

### 2. Discussion of Related Art

A current trend is a large increase in the use of electronic books (or e-books) instead of newspapers or books, which are made of paper, along with various applications of portable terminals. An e-book is a specially-formatted file with a kind of software and may be freely downloaded or used by a smartphone, a pad, or a personal computer (PC) through an online market. However, for the purpose of copyright protection, there are differences for each user when e-books are accessed.

Generally, paper books somewhat lack durability or rapidity while e-books cover such disadvantages of paper books and additionally support functions such as underlining, a keyword search, and a simple memo for user convenience. Accordingly, e-books are getting the spotlight as a substitute for paper books.

However, although e-books have an advantage of being able to replace paper books in many ways, it is somewhat unreasonable to assume that e-books will absorb all advantages of paper books. As an example, it is easy for several people in turn to read a paper book or for a person to show a sentence that impressed him or her to anyone. However, e-books cannot yet be assumed to be convenient in these situations.

Also, content may be simply shared with other users by lending a paper book wholly or copying some pages thereof. However, it is cumbersome to share e-books with other users due to ownership of content and e-books are different from paper books, which have analogue excitement, in terms of readability of content. Accordingly, technically solving these problems is a challenge.

As a related art, Korean Patent No. 10-1323264 (entitled “METHOD, SERVER AND COMPUTER-READABLE RECORDING MEDIUM FOR SHARING PHRASE INCLUDED IN E-BOOK IMAGE”) discloses sharing of a portion of e-book content with other users.

### SUMMARY OF THE INVENTION

According to a first aspect of the disclosed technique, there is provided an e-book system including a first terminal configured to receive some characters selected from among a plurality of characters included in content of an e-book through an interface, process the received characters as a first area, and generate address data using ID values for the first area, an e-book server configured to receive the address data from the first terminal, register the received address data in a database, and process an access of at least one terminal to the first area according to a result of comparing address data transmitted from the at least one terminal with the registered address data, and a second terminal configured to receive the address data from the first terminal, access the first area of the e-book server on the basis of the address data, and output the first area on a screen thereof.

According to a second aspect of the disclosed technique, there is provided an e-book system including a first terminal configured to receive some characters selected from among a plurality of characters included in content of an e-book through an interface, process the selected characters as a first area, and request address data using ID values for the first area, an e-book server configured to receive the request from the first terminal, generate and register the address data, transmit the registered address data to the first terminal, determine whether address data transmitted from at least one terminal after the registered address data is transmitted matches the registered address data, and process an access of the at least one terminal to the first area according to a result of the determination, and a second terminal configured to receive the address data from the first terminal, access the first area of the e-book server on the basis of the address data, and output the first area on a screen thereof.

According to a third aspect of the disclosed technique, there is provided an e-book terminal including an extraction unit configured to extract content included in an e-book, an ID value setting unit configured to individually classify a plurality of characters included in the content of the e-book and assign an ID value to each of the characters, an area processing unit configured to, when some of the content of the e-book is designated through an input unit of a system, process the designated content as a first area and check ID values for the first area, and an address data generation unit configured to generate address data for the first area with reference to the ID values for the first area.

According to a fourth aspect of the disclosed technique, there is provided an e-book server including a database configured to receive address data for a first area of content of an e-book from a first terminal and register the received address data and an address data processing unit configured to process an access of at least one terminal to the first area according to a result of comparing address data transmitted from the at least one terminal with the registered address data.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram showing a system for generating address data of some content included in an e-book according to an embodiment of the disclosed technique;

FIG. 2 is a diagram showing an operational flow of a system for generating address data of some content included in an e-book according to an embodiment of the disclosed technique;

FIG. 3 is a block diagram showing a system for generating address data of some content included in an e-book according to another embodiment of the disclosed technique;

FIG. 4 is a diagram showing an operational flow of a system for generating address data of some content included in an e-book according to an embodiment of the disclosed technique;

FIG. 5 is a block diagram showing a terminal for generating address data of some content included in an e-book according to an embodiment of the disclosed technique;

FIG. 6 is a block diagram showing an e-book server for processing address data of some content included in an e-book according to an embodiment of the disclosed technique;

FIG. 7 is a diagram showing e-book content;

FIG. 8 is a diagram showing a selection of a first area in e-book content;

FIG. 9 is a diagram showing a screen of a second terminal that accesses a first area using address data; and

FIG. 10 is a diagram showing access of another terminal to a first area using address data.

### DETAILED DESCRIPTION OF EXEMPLARY EMBODIMENTS

While the invention is susceptible to various modifications and alternative forms, specific embodiments thereof will be shown by way of example in the drawings and will herein be described in detail. It should be understood, however, that there is no intent to limit the invention to the particular forms disclosed, and conversely, the invention is to cover all modifications, equivalents, and alternatives falling within the spirit and scope of the invention.

Although terms such as “first,” “second,” “A,” and “B” can be used for describing various components, the components may not limited by the terms. The terms are used only for distinguishing one component from another component. For example, a first element may be called a second element, and a second element may also be called a first element without departing from the scope of the present disclosure. The term “and/or” includes any and all combinations of one or more of associated listed items.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Prior to a detailed description of the drawings, it should be clarified that division of components in the present specification is merely performed on the basis of main functions performed by the respective components. That is, two or more components which will be described later may be integrated into a single component or, alternatively, a single component may be provided to be divided into two or more components depending on subdivided functions thereof.

Further, it should be apparent that each of the components, which will be described later, may additionally perform some or all of functions performed by other components in addition to main functions performed thereby, and some of the main functions performed by the respective components may be shared with other components and performed. Therefore, the presence or absence of individual components as described in the present specification should be functionally interpreted.

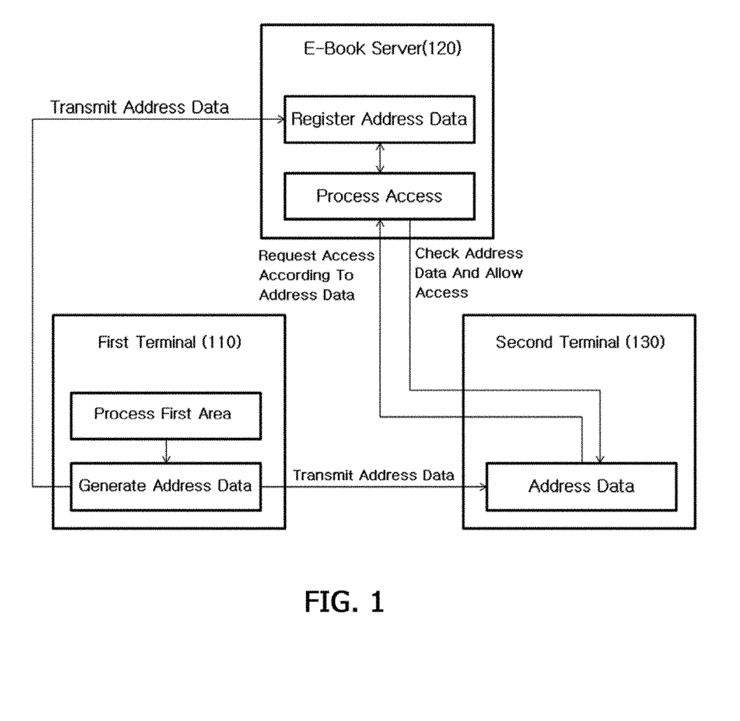

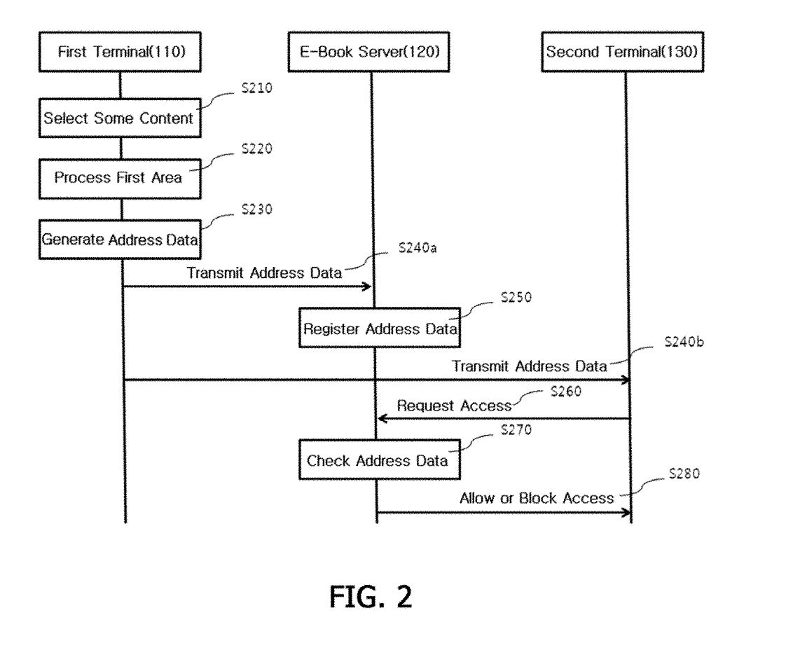

FIG. 1 is a block diagram showing a system for generating address data of some content included in an e-book according to an embodiment of the disclosed technique. Also, FIG. 2 is a diagram showing an operational flow of a system for generating address data of some content included in an e-book according to an embodiment of the disclosed technique. Referring to FIGS. 1 and 2, the system for generating address data of some content included in an e-book includes a first terminal 110, an e-book server 120, and a second terminal 130.

The first terminal 110 refers to a terminal that outputs e-book content to a screen thereof. For example, the first terminal 110 may be a smartphone or a tablet. Also, the first terminal 110 may download a predetermined e-book from the e-book server 120 in advance or may access the e-book server 120 to read an e-book.

The first terminal 110 is capable of selecting some content from the e-book. As an embodiment, the first terminal 110 may include a predetermined interface and select some content from the e-book through the interface. Here, the e-book includes at least one piece of content. That is, like conventional paper books, the e-book may include a large number of characters, illustrations, formulas, charts, and the like as the content.

The first terminal 110 selects some of the content. For example, in S210, the first terminal 110 may select some characters from among a plurality of characters included in the content. The characters may be selected using the above-described interface. When the first terminal 110 is a smartphone, the characters may be selected by tapping or dragging on a touch screen included in the smartphone. When the first terminal 110 is a tablet, the content may be selected using a tool such as an electronic pen or a mouse.

When some of the content is selected in this way, the first terminal 110 processes the content as a first area. Here, the first area includes information regarding the selected characters. As an embodiment, when a user selects some of the content through an interface in step S220, the first terminal 110 may process the first area with reference to an ID value assigned in advance to each of the characters included in the content.

When the first terminal 110 downloads an e-book or accesses the server 120 to read an e-book, the first terminal 110 generates an ID value for each character included in content of the e-book. For example, when a unique ID value is assigned to each of the characters before the first area is selected and the first area is selected according to a user's input, the first terminal 110 may process the first area with reference to the ID values of characters included in the first area.

The first terminal 110 may process the first area on the basis of ID values of the first and last characters of the characters selected by the user. For example, when e-book content includes the quote “To be, or not to be, that is the question: Whether 'tis nobler in the mind to suffer The slings and arrows of outrageous fortune,” and a user selects the portion “To be, or not to be, that is the question,” the first terminal 110 may check ID values assigned to the first “T” and the last “,” of the selected area, and may process the first area on the basis of the ID values.

Here, the ID value assigned to each character is unique. Even when the text includes the same syllable or character, the same ID value is not repeatedly assigned thereto. According, even when a terminal other than the first terminal 110 processes the same portion as the first area, the first area is generated to have the same value.

The first terminal 110 generates address data for the first area on the basis of the processed first area. As an embodiment, the first terminal 110 may receive information regarding the first area and generate the address data for the first area in step S230. Here, the address data for the first area may include ID values of the designated first and last characters.

The first terminal 110 generates the address data for the first area with reference to ID values included in the first area. Here, the address data functions as a link to some of the content to be shared by a user of the first terminal 110 with a user of the second terminal 130. As an embodiment, the address data may be a uniform resource locator (URL) or link that is connected to a specific website for reading the e-book or a webpage for providing the e-book when the address data is entered through a copy-and-paste operation. Here, the address data may be displayed in the form of a Short Message Service (SMS) or a Multimedia Messaging Service (MMS) so that the address data is received or transmitted between terminals, and the user of the second terminal 130 may receive such address data in the form of a message and access the first area to be shared by the user of the first terminal 110 by tapping or clicking a link or URL included in the message.

When the address data is generated, the first terminal 110 transmits the generated address data to the e-book server 120 and the second terminal 130. For example, in steps S240A and S240B, the first terminal 110 may transmit the address data to the e-book server 120 and the second terminal 130. Here, steps S240A and S240B may be performed sequentially or simultaneously. It does not take much time to perform a registration process on the address data even when the steps are performed simultaneously. Accordingly, the probability of an error occurring is extremely small when the second terminal 130 accesses e-book content through the address data.

In step S250, the e-book server 120 receives the address data and registers the address data so that the user of the second terminal 130 may access the address data. The user of the second terminal 130 may receive the address data registered by the server from the first terminal 110 and access the first area of the e-book content.

The address data generated by the first terminal 110 may be transmitted to at least one other terminal as well as the second terminal 130. For example, as described above, the address data may be sequentially or collectively transmitted to terminals in the form of a message such as an SMS or MMS. It should be appreciated that, unlike the above-description, the address data may be transmitted over an e-mail or in the form of chatting through social networking services (SNSs) or messengers. When the address data is received, the terminals may access the first area to be shared by the user of the first terminal 110 using the address data.

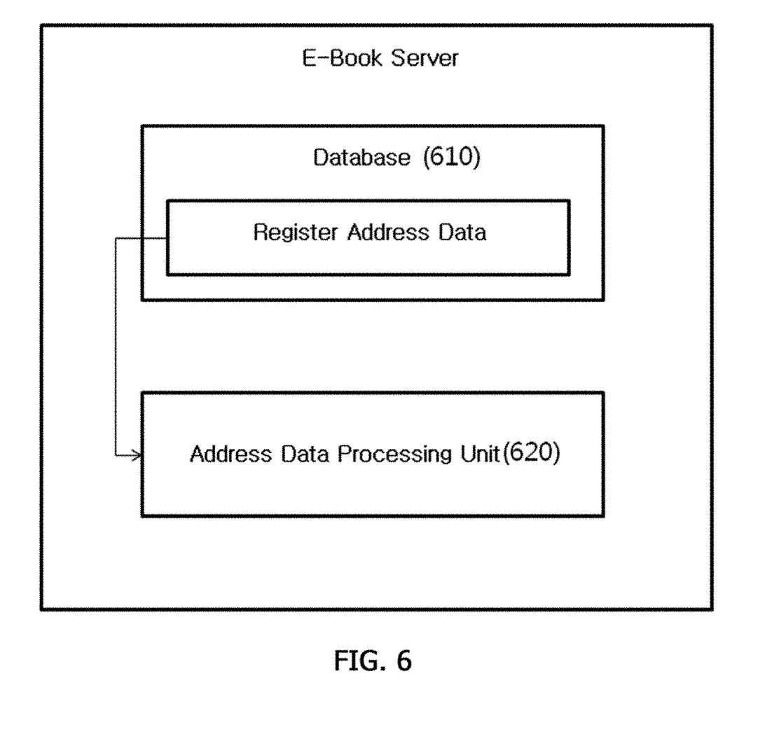

The e-book server 120 registers the address data received from the first terminal 110 as described above. Also, the e-book server 120 processes access to registered address data and unregistered address data. Referring to FIG. 6, the e-book server 120 may include a database and an address data processing unit and may register the address data received from the first terminal 110 in the database. Also, the e-book server 120 may use the address data processing unit to block an access corresponding to address data that is different from the registered address data or address data that is arbitrarily changed or manipulated by a terminal that received the address data. Here, the address data may be displayed in the form of a URL including an ID value, and a user may arbitrarily change the ID value of the URL to another ID value. However, since the URL having the ID value changed in this way is address data that is unregistered in the e-book server 120, other terminals cannot access areas of the e-book other than the first area using the URL.

When the second terminal 130 accesses the e-book server 120 using the address data received from the first terminal 110 as it is, the e-book server 120 may allow the access. When the second terminal 130 accesses the e-book server 120 using a changed value of the address data, the e-book server 120 may block the access. Also, when the e-book server 120 blocks the access to the content, the e-book server 120 may output a page for purchasing the content.

When the content of the e-book is subject to copyright protection, the e-book server 120 may perform a blurring or shading process on the content of the e-book except for the content corresponding to the address data. When the content of the e-book is not subject to copyright protection, the e-book server 120 may reveal all of the content. As an embodiment, when the content is subject to copyright protection, the e-book server 120 may reveal only the first area corresponding to the address data or only some pages including the first area and perform a blurring or shading process on the remaining content. Conversely, when the content is not subject to copyright protection, the e-book server 120 may reveal all of the content because the content except for the first area does not need to be hidden. When the e-book content is subject to copyright protection, the e-book server 120 may reveal only some pages preceding and following the first area and then output a purchase page for the content without revealing the other pages.

In step S260, the second terminal 130 requests access to the e-book content using the address data received from the first terminal 110. In step S270, the e-book server 120 checks whether the address data is registered and processes the access of the second terminal 130.

The second terminal 130 outputs the first area corresponding to the address data to a screen thereof. As an embodiment, the second terminal 130 may perform at least one of background coloring, underlining, and highlighting operations on the content corresponding to the first area before outputting the first area to the screen. Accordingly, the user of the first terminal 110 may share some characters of the e-book content to be shared with the user of the second terminal 130 and users of other terminals, and the e-book server 120 may process accesses of the terminals using the registered address data.

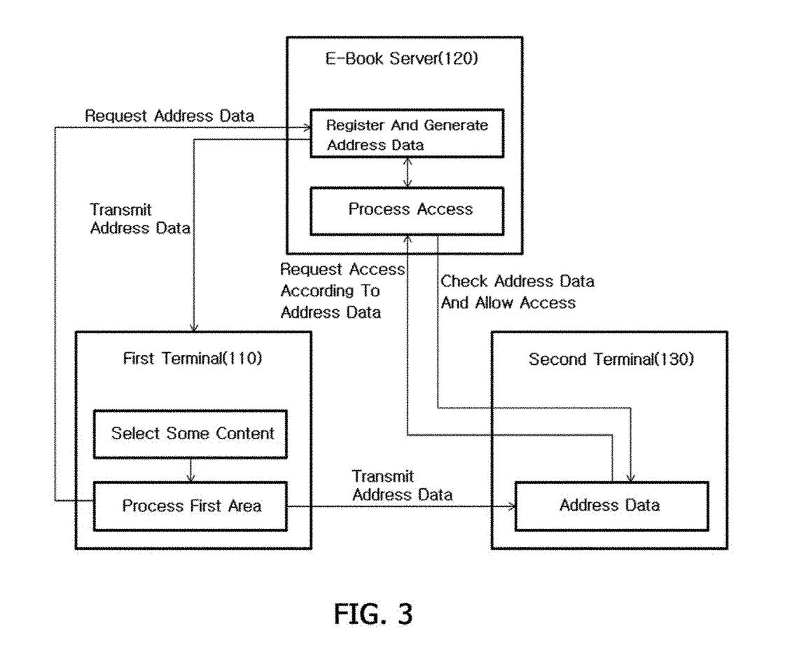

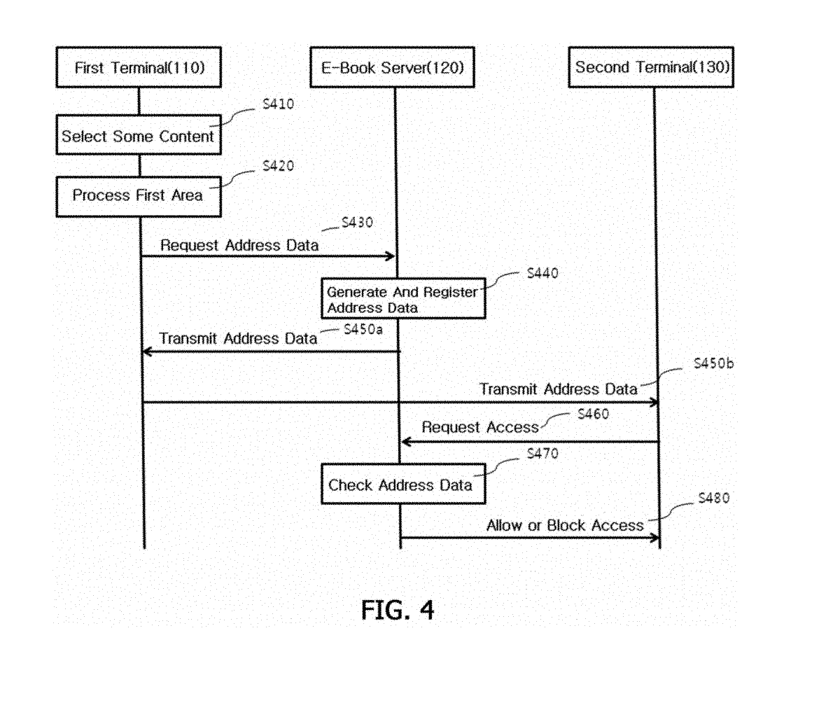

Referring to FIGS. 3 and 4, in the system for generating address data of some content included in an e-book, the e-book server 120 may generate address data instead of the first terminal 110. As an embodiment, the first terminal 110 may select some characters included in e-book content in step S410, process the selected characters as a first area in step S420, and transmit the first area to the e-book server 120 to request that the e-book server 120 generate address data in step S430. The e-book server 120 may generate and register the address data in response to the request in step S440 and send the registered address data back to the first terminal 110 in step S450A.

The first terminal 110 may transmit the received address data to the second terminal 130 in step S450B. The second terminal 130 may send an access request to the e-book server 120 using the received address data in step S460. When the request is received, the e-book server 120 may check whether the address data is registered in step S470 and may allow or block the access of the second terminal 130 in step S480. Accordingly, the e-book server 120 may process the request corresponding to the generation of the address data.

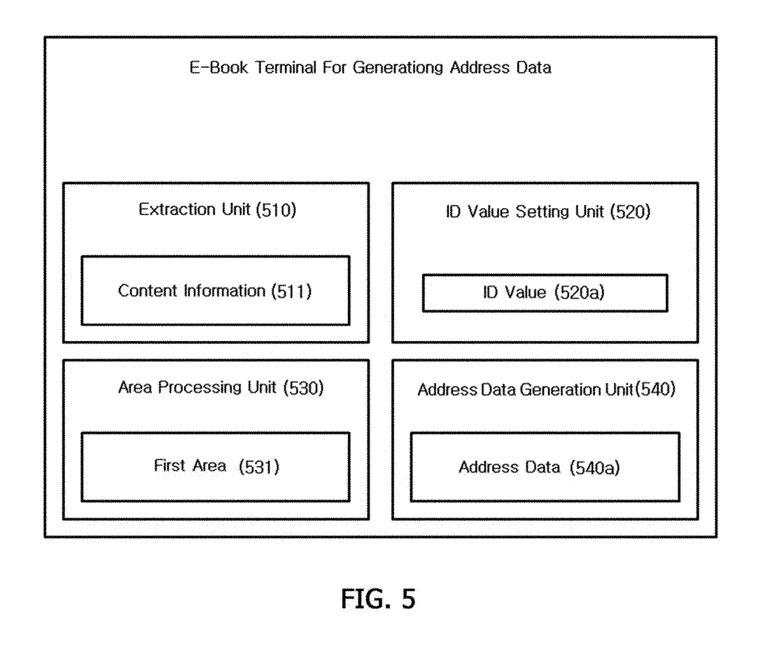

FIG. 5 is a block diagram showing a terminal for generating address data of some content included in an e-book according to an embodiment of the disclosed technique. Referring to FIG. 5, the terminal for generating address data of some content included in an e-book includes an extraction unit 510, an ID value setting unit 520, an area processing unit 530, and an address data generation unit 540.

Each element included in the terminal may be implemented with units such as a central processing unit (CPU), a processor, and a memory that are installed in the terminal. For example, when the terminal is a smartphone, an application processor installed in the smartphone may serve as each element.

The extraction unit 510 extracts content information 511 included in an e-book. Generally, e-books are produced not in an integrated form or specification such as one specific solution or platform but in different forms for each publishing company or each country. Accordingly, since content included in an e-book does not have a uniform form, the extraction unit 510 extracts several pieces of content included in the e-book and internally identifies the extracted pieces of content as the content information 511.

Here, in view of characteristics of the e-book, the content information 511 may basically include text and may further include an image associated with the content. It should be appreciated that the content information 511 also includes several punctuation marks or spaces included in the text.

The ID value setting unit 520 individually classifies a plurality of characters included in the content information 511. As an embodiment, the content of the e-book composed of a plurality of characters may be classified into individual characters. When the characters are Hangul characters, which are the Korean alphabet, the characters may be classified on the basis of syllables such as a vowel, a consonant+a vowel, a vowel+a consonant, and a consonant+a vowel+a consonant. Also, when the characters are the English alphabet, the characters may be classified into individual letters. It should be appreciated that a punctuation mark or a space may be classified as a character. The ID value setting unit 520 assigns an ID value 520a to each individual character. Here, the ID value 520a may be assumed to be a kind of index value matching one character, which may allow a user to directly check a corresponding value when the user select the ID value 520a.

As an embodiment, characters included in the content information 511 are “Ga Na Da Ra Ma,” and the ID value setting unit 520 may assign one ID value to each of the characters by assigning an ID value “a” to “Ga,” assigning an ID value “b” to “Na,” assigning an ID value “c” to “Da,” and so on. As another embodiment, when text included in the content information 511 is “peace,” the ID value setting unit 520 may assign ID values “0001,” “0010,” “0011,” “0100,” and “0101” to the first character “p,” the second character “e,” the third character “a,” the fourth character “c,” and the fifth character “e,” respectively. That is, the ID value setting unit 520 may assign different unique ID values to the same character “e.” As described above, each space between the characters may be classified as one syllable to have an ID value assigned thereto, and also each punctuation mark, such as a quotation mark or comma, may have an ID value assigned thereto.

Even when the same syllable is present in the characters included in the content information 511, the ID value setting unit 520 may assign different ID values to the syllables and distinguish the syllables from each other because the ID value 520a is a kind of unique value. The ID value setting unit 520 performs the process such that ID values assigned to characters are different from each other.

When some content included in the e-book is designated through an input unit of the terminal, the area processing unit 530 processes the designated content as a first area 531. Also, the area processing unit checks ID values for the first area 531. A reader of the e-book may freely designate some of the content using an input unit included in his or her terminal in order to share specific information with other users.

As an embodiment, the reader may designate some of the content by dragging with a mouse or double-tapping or dragging with fingers or a dedicated smart-terminal electronic pen.

When some of the content of the e-book is designated as described above, the area processing unit 530 processes the designated portion as the first area 531. Here, the area processing unit 530 may search for the first and last characters of the designated some content and process characters ranging from the first character to the last character as the first area 531. The first area 531 is displayed on a screen of an e-book terminal through an additional effect so that the first area 531 may be easily and visually checked by a user of the e-book terminal. For example, emphasis may be put on the first area 531 by underlining or highlighting the first area 531.

When the first area 531 is set as described above, the area processing unit 530 checks the ID values for the first area 531. As an embodiment, the area processing unit 530 may search for the first and last characters and check ID values of the first to last characters.

The address data generation unit 540 generates address data 540a for the first area 531. As an embodiment, the address data generation unit 540 may generate the address data 540a for the first area 531 using ID values included in the first area 531. Here, the address data 540a is generated in the form of a URL or link. Also, the ID values for the first area 531 may be included as a portion of the URL. For example, in a URL such as “http://www.bukio.com/content1/page202/ID:0123˜ID:0150,” ID values “0123” and “0150” may be included at the end of the URL.

Only some content corresponding to the address data 540a is displayed on a screen of at least one user terminal that received the address data 540a. In a related art, for example, when a URL of a webpage including some content is shared with a third party in order to quote or share the content through the webpage, there is an inconvenience in that the third party should receive the URL, perform an accessing operation using the URL, and then search for and find the content.

However, according to the disclosed technique, it is possible to directly move to a position of some content of an e-book by using address data. For example, when other user terminals access the content of the e-book through the URL or link, the content except for the first area 531 may be shaded or blurred to prevent a copyright issue or the like from occurring, and only information corresponding to the first area 531 may be displayed by being underlined or having a background thereof colored.

It should be appreciated that all content irrelevant to such an issue may be displayed on the screen and also that only a portion corresponding to the address data may be recognizably displayed so that a user may continuously view the content. That is, by generating address data of a portion of text, the disclosed technique is more simplified and convenient when compared to a case in which the text is just copied, shared, or lent.

Accordingly, it is possible for a user who generates address data to deliver desired information to other users without an unnecessary or cumbersome process, and it is also possible for a user who receives the address data to directly access content of an e-book without a separate authentication process or the like.

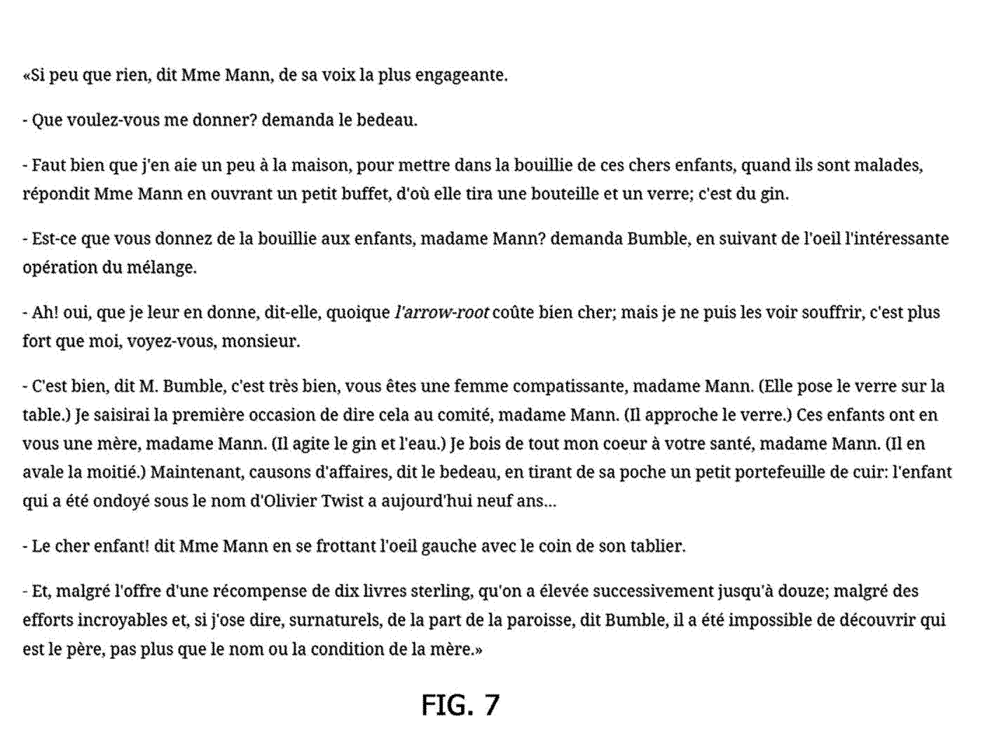

FIGS. 7 to 10 are diagrams showing embodiments of using address data. Referring to FIGS. 7 to 10, it can be seen that specific information is shared by generating address data and transmitting the generated address data to other users.

First, referring to FIG. 7, e-book content according to the disclosed technique is provided through the e-book server 120. Since a plurality of e-books are uploaded to the e-book server 120, the e-book server 120 may provide a service through which a user may download a desired e-book by accessing the e-book server 120 through his or her terminal 110. In this case, the server 120 may provide a service through which an e-book is downloaded free of charge or for a fee depending on the type thereof. When an e-book is downloaded for a fee, a user may download the e-book for the fee according to a predetermined payment method.

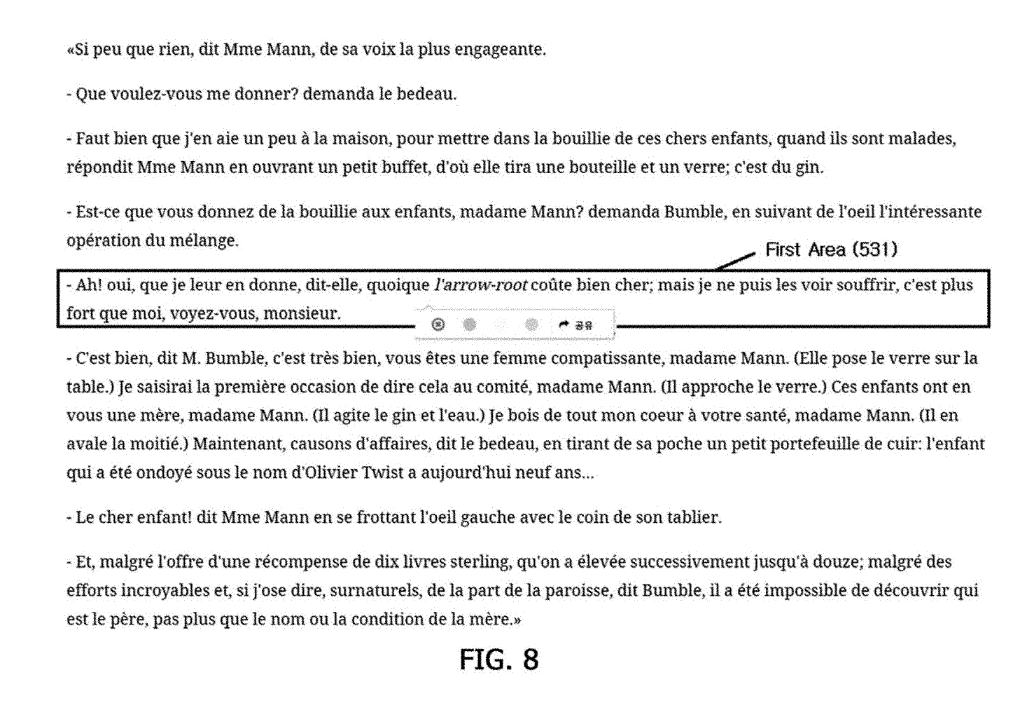

As shown in FIG. 7, when an e-book is downloaded and opened, content of the e-book may be checked. Generally, the content is mainly composed of text, but illustrations or charts may be added depending on the type of book. Referring to FIG. 8, it can be seen that the user designates some of the content as the first area 531 in order to deliver specified information to other users while reading the e-book. As shown, a part displayed with a box is the first area 531, and this part may be actually displayed on a terminal through an interface. As an embodiment, when a terminal for reading the e-book is a PC, the first area 531 may be designated by dragging with a mouse. As another embodiment, when the e-book is read through a smartphone or a tablet PC, the first area 531 may be designated by long-tapping or double-tapping with fingers or a touch pen.

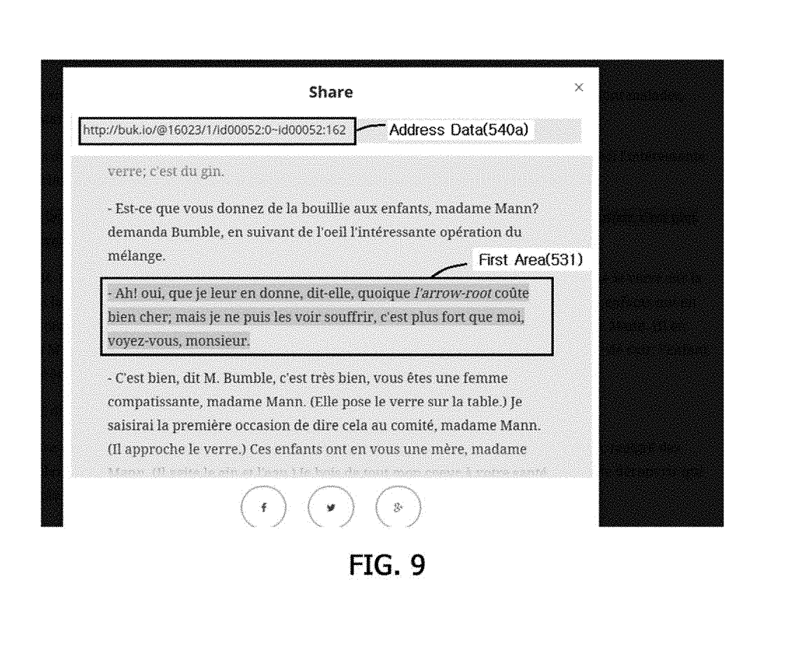

When the first area 531 is designated as described above, address data for the corresponding area may be generated in order for other users to access some content corresponding to the designated area. That is, as shown in FIG. 9, the address data 540a may be generated in the form of a URL. Referring to a URL displayed with a box, the URL includes information regarding which server provides e-book content, which e-book is being accessed, and which part is the first area 531 of the e-book content. That is, the address data 540a displayed in the form of a URL includes information for identifying the e-book server, the e-book content, and the first area 531. As shown in FIG. 9, when the URL is “http://buk.io/@16023/1/id00052:0˜id00052:162,” the part “buk.io” may be information indicating the name of a server, the part “@16023/1” may be information indicating the 16,023^{rd} book registered in the server, and the part “id00052:0˜id00052:162” may indicate the first to 163^{rd} ID values of the 52^{nd} paragraph.

When the address data is represented in the form of a URL, pieces of data including each part of the URL may be distinguished from each other. When the e-book server 120 receives the address data 540a or generates the address data 540a in response to a request of the first terminal 110, the e-book server 120 may separately store only a portion of the address data 540a in the e-book server 120 so that the first area 531 may be identified from the address data 540a. For example, since the part “buk.io” of the URL is not information regarding which e-book is being accessed and which part of the e-book is referred to but is just a part for referring to the server from a server standpoint, the e-book server 120 may omit this part and may separately store only the part “@16023/1/id00052:0˜id00052:162.” Also, the e-book server 120 may identify which part of which e-book is the first area on the basis of this information.

It should be appreciated that other users may access corresponding information by generating a posted article or connecting a link thereto through an SNS like a conventional technique. However, in this case, unlike the method of using address data, conventional problems still exist because a user should access the SNS and a right to view the posted article is restricted according to settings of a publication range of the posted article. Accordingly, the address data is used to simplify the process and provide user convenience. Also, for a conventional content sharing method, a link may be generated in a similar way to that of the address data. Generally, the link is present in a specific form through which a server may recognize data to be shared, and address data is not generated in the form of a unique URL. That is, when different users generate two links by using the conventional content sharing method to share the same information with a third party, the links may be displayed in different forms although the links indicate the same information. However, according to the disclosed technique, even when a user generates a link, it is possible to generate a unique URL or a unique link with reference to a unique ID value assigned to each character.

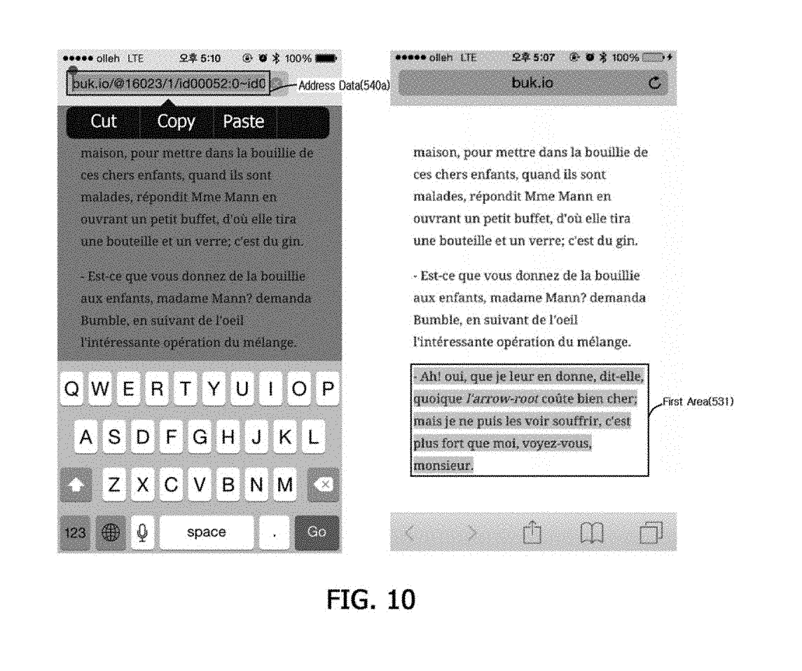

FIG. 10 is a diagram showing access of another terminal to the first area 531 using address data. When the address data 540a is received from the user of the first terminal 110, the user of the second terminal 130 may receive the address data 540a in the form of a message. In this case, it is possible to input the address data 540a to an address window of a browser to directly access the first area 531 of the e-book according to the address data 540a. Also, the user of the second terminal 130 may transmit the address data 540a received in the form of a message to terminals of other users or another terminal of the user to access the first area 531. For example, the address data 540a may be received by a smartphone or a notebook to access the first area 531. In this case, a configuration or arrangement of output content may somewhat vary depending on the type of terminal or a size of a screen. For example, as shown in FIG. 10, a width of a paragraph may somewhat decrease, and the number of lines may somewhat increase. However, information to be shared is not changed because the address data for the first area 531 is generated on the basis of ID values.

As shown in FIG. 10, only the first area 531 corresponding to the address data may be highlighted while the entire information is displayed on a screen, or only the first area 531 corresponding to the address data is displayed while the information except for the first area 531 may be processed to be blurred or empty. As an embodiment, when content is information of an e-book that is paid for, a recipient is restricted to access only some content corresponding to the address data because the recipient did not purchase the e-book.

The system, terminal, and server for generating address data of some content included in an e-book according to an embodiment of the disclosed technique have been described with reference to the embodiments shown in the drawings for a better understanding. However, these are merely examples, and it should be understood by those skilled in the art that various modifications and equivalents may be made. Accordingly, the technical scope of the disclosed technique should be determined only by the appended claims.

What is claimed is:

1. An e-book system comprising:
a first terminal configured to selected characters from among a plurality of characters included in content of an e-book through an interface, process the selected characters as a first area, and generate address data using ID values for the first area;
an e-book server configured to receive the address data from the first terminal, register the received address data in a database, and process an access of at least one terminal to the first area according to a result of comparing address data transmitted from the at least one terminal with the registered address data; and
a second terminal configured to receive the address data from the first terminal, access the first area of the e-book server on the basis of the address data, and output the first area on a screen thereof.

2. The e-book system of claim 1, wherein the first terminal processes the first area on the basis of ID values of first and last characters of the selected characters from among the plurality of characters.

3. The e-book system of claim 2, wherein the first terminal generates unique address data including the ID values of the first and last characters.

4. The e-book system of claim 1, wherein the first terminal comprises an address data transmission unit configured to transmit the address data to the e-book server and the second terminal.

5. The e-book system of claim 1, wherein, when the address data is received, the e-book server blocks an access corresponding to address data that is different from the received address data or address data that is obtained by changing or manipulating the received address data.

6. The e-book system of claim 1, wherein when the second terminal accesses the e-book server using the received address data, the e-book server allows the access, and when the second terminal accesses the e-book server using address data that is different from the received address data, the e-book server blocks the access.

7. The e-book system of claim 1, wherein when the content of the e-book is subject to copyright protection, the e-book server performs a blurring or shading process on the content of the e-book except for some content corresponding to the address data, and when the content of the e-book is not subject to copyright protection, the e-book server reveals all of the content of the e-book.

8. The e-book system of claim 1, wherein the address data is a uniform resource locator (URL) or link corresponding to the first area.

9. The e-book system of claim 1, wherein the address data includes information for identifying the e-book server, information for identifying the content of the e-book, and information for identifying the first area.

10. The e-book system of claim 1, wherein the second terminal performs at least one of background coloring, underlining, and highlighting operations on some content corresponding to the first area when outputting the first area to the screen.

11. The e-book system of claim 1, wherein the e-book server includes an address data processing unit, and the address data processing unit allows the access of the second terminal when the address data for the first area matches address data transmitted by the second terminal.

12. The e-book system of claim 1, wherein the e-book server blocks an access that uses address data other than the registered address data.

13. The e-book system of claim 1, wherein when the e-book is subject to copyright protection, the e-book server performs a blurring or shading process on the content except for the first area, and when the e-book is not subject to copyright protection, the e-book server reveals all of the content including the first area.

14. An e-book system comprising:
a first terminal configured selected characters from among a plurality of characters included in content of an e-book through an interface, process the selected characters as a first area, and request address data using ID values for the first area;
an e-book server configured to receive the request from the first terminal, generate and register the address data, transmit the registered address data to the first terminal, determine whether address data transmitted from at least one terminal after the registered address data is transmitted matches the registered address data, and process an access of the at least one terminal to the first area according to a result of the determination; and
a second terminal configured to receive the address data from the first terminal, access the first area of the e-book server on the basis of the address data, and output the first area on a screen thereof.

15. An e-book terminal comprising:
an extraction unit configured to extract content included in an e-book;
an ID value setting unit configured to individually classify a plurality of characters included in the content of the e-book and assign an ID value to each of the characters;
an area processing unit configured to, when some of the content of the e-book is designated through an input unit of a system, process the designated content as a first area and check ID values for the first area; and
an address data generation unit configured to generate address data for the first area with reference to the ID values for the first area.

16. The e-book terminal of claim 15, wherein the ID value setting unit generates a plurality of unique ID values that match the plurality of characters.

17. The e-book terminal of claim 15, wherein the area processing unit searches for first and last characters of the designated content and processes characters ranging from the first character to the last character as the first area.

18. The e-book terminal of claim 15, wherein the address data generation unit further includes an address data transmission unit, and the address data transmission unit transmits the address data for the first area to a server for providing the e-book and at least one user terminal.

19. The e-book terminal of claim 15, wherein the address data is a uniform resource locator (URL) or link to the first area.

20. An e-book server comprising:
a database configured to receive address data for a first area of content of an e-book from a first terminal and register the received address data; and
an address data processing unit configured to process an access of at least one terminal to the first area according to a result of comparing address data transmitted from the at least one terminal with the registered address data.

21. The e-book server of claim 20, wherein the address data processing unit allows the access of the at least one terminal to the first area of the e-book server when the address data for the first area and the address data transmitted by the at least one terminal match.

22. The e-book server of claim 20, wherein after the address data is registered, the e-book server blocks an access corresponding to address data that is different from the registered address data or address data that is obtained by changing or manipulating the registered address data.

23. The e-book server of claim 20, wherein when the at least one terminal accesses the e-book server using the address data received through the first terminal, the e-book server allows the access, and when the at least one terminal accesses the e-book server using address data that is different from the received address data, the e-book server blocks the access.

24. The e-book server of claim 20, wherein when the content of the e-book is subject to copyright protection, the e-book server performs a blurring or shading process on the content of the e-book except for some content corresponding to the address data, and when the content of the e-book is not subject to copyright protection, the e-book server reveals all of the content of the e-book.

25. The e-book server of claim 20, wherein the address data is a uniform resource locator (URL) or link corresponding to the first area.

26. The e-book server of claim 20, wherein the address data includes information for identifying the e-book server, information for identifying the content of the e-book, and information for identifying the first area.
